(19) United States
(12) Patent Application Publication
(10) Pub. No.: US 2008/0169060 A1
(43) Pub. Date: Jul. 17, 2008

(54) Method of fabricating carbon nanotube pattern

(75) Inventors: Jeng-Rong Ho, Taipei (TW); Jungwei John Cheng, Chia-Yi (TW); Cheng-Kuo Sung, Hsinchu (TW); Shiang-Kuo Chang-Jian, Kaohsiung City (TW)

Correspondence Address: BIRCH STEWART KOLASCH & BIRCH, PO BOX 747, FALLS CHURCH, VA, 22040-0747, US

(73) Assignee: National Chung Cheng University

(21) Appl. No.: 11/882,025

(22) Filed: Jul. 30, 2007

(30) Foreign Application Priority Data
Jul. 31, 2006 (TW) 095128022

(51) Int. Cl. B32B 37/06

(52) U.S. Cl. 156/272.8

(57) ABSTRACT

A method of fabricating carbon nanotube (CNT) pattern includes the following steps. First, one surface of a first transparent substrate is denoted as the first surface. A CNT thin film layer is coated on the first surface by a thin film deposition method. Then, a second substrate is disposed opposite to the first surface coated with a CNT thin film layer. By adopting a laser transfer method, a laser source irradiates on the CNT thin film layer coated on the fist surface, such that the CNT on the irradiated area explodes to depart from the first surface due to the high temperature resulted from the energy imparted by the laser light, so as to form a CNT pattern on the opposite second substrate.

### CROSS-REFERENCE TO RELATED APPLICATIONS

This non-provisional application claims priority under 35 U.S.C. § 119(a) on Patent Application No(s). 095128022 filed in Taiwan, R.O.C. on Jul. 31, 2006, the entire contents of which are hereby incorporated by reference.

### BACKGROUND OF THE INVENTION

1. Field of Invention

The present invention relates to a method of fabricating carbon nanotube (CNT) pattern. More particularly, the present invention relates to a method of fabricating CNT patterns by using a laser transfer technique.

2. Related Art

Discovery of the CNT is an important topic of the nano technology with many potentially useful applications. Besides the special structural shape thereof, the CNT is special in its properties which make it a favorable application material. The material has the properties such as high elasticity, high tensile strength and light weight, and has the property of both metal and semiconductor. Further, the CNT has a high field emission current and low starting voltage, so it has the potential to be applied to the field emission display.

Carbon Nanotube Field Emission Display (CNT-FED) has been recognized as one of the major flat panel display techniques of the next generation, and many techniques of fabricating the CNT-FED has been researched and developed. Recently, the main challenge in research and development relates to how to uniformly and stably attach the CNT in patterns on a conductive substrate. Nowadays, the techniques commonly used to fabricate the CNT pattern include Screen Printing, Chemical Vapor Deposition (CVD), and Electrophoresis Deposition (EPD).

For the conventional CVD manufacturing process, the CNT is deposited on a catalyst metal layer to form a cathode conductive substrate. Although in the manufacturing process the CNTs with the uniform length may be grown, one end of each CNT grown by the method may have catalyst metal remained, and the remaining catalyst metal may affect the electric field emission efficiency of the CNT. Therefore, a surface processing process must be added to increase the electric emission efficiency, however, the cost of the manufacturing process is thus increased. Furthermore, the whole manufacturing process is required to be performed in the vacuum environment of high temperature; thus it is not suitable for mass production.

Another conventional method of fabricating the CNT pattern is printing the silver paste mixing with the CNT's onto the cathode substrate by employing the screen printing method. Although the screen printing successfully creates CNT pattern with good adhesion to the cathode substrate, it has inherent deficiencies. Because of the nonuniform tension of the screen, the problems concerning unfavorable uniformity of the film thickness and distorted printing pattern are resulted; in consequence, the electric field intensity is not uniform, and the light emission uniformity is affected. The most serious hidden problem of the screen printing is that because the printed CNT's are covered by the silver paste, the intensity and uniformity of the field emission current are affected.

Further, in the conventional EPD method, the CNT's are deposited in patterns on a substrate covered with conductive adhesive or directly on a conductive substrate through the electrophoresis process. Like any electrophoresis process, the stable dispersion uniformity of the CNT colloid and the uniformity of the conductive adhesive on the substrate or the surface characteristics on the conductive substrate may greatly affect the uniformity of the deposited CNT pattern. Therefore, how to stably disperse CNT's in the suspension and the request for high uniformity in surface characteristics of the substrate become great technical challenges of the EPD method. Moreover, the adhesion between the electrophoretically deposited CNT's and the conductive adhesive or the substrate itself poses another technical challenge.

Therefore, in manufacture of the CNT-FED, it is required to provide a method of fabricating the CNT pattern with preferable uniformity and reliable adhesion and suitable for mass production.

### SUMMARY OF THE INVENTION

In view of the above mentioned problems of the conventional means, the present invention discloses a new method for fabricating CNT thin film in patterns, adopting a combination of the thin film deposition method and the laser transfer technique. In the method of the present invention, a first substrate is provided first, a first surface is disposed on the first substrate, and a uniformly distributed CNT thin film layer is covered on the first surface by a thin film deposition method. Next, a second substrate is provided, a second surface corresponding to the first surface is disposed on the second substrate. A laser emitter is provided to emit a laser beam to the first substrate, such that the irradiated CNT thin film layer on the first surface explodes to depart from the first surface due to the high temperature, and attaches onto the second surface corresponding to the first surface, thus forming a CNT pattern.

The function of the present invention lies in that, by selecting an appropriate thin film deposition method, the thin film layer with uniformly distributed CNT is obtained. Also, a layer of adhesive material is covered on the second surface first, then the uniformly distributed CNT is transferred and embedded in the adhesive material by the laser transfer method, or the CNT thin film mixing with the adhesive material is directly used, and the adhesive material and the CNT are transferred together and stably attached on the second substrate by the laser transfer method, so as to solve the problem of unpreferable adhesion of the CNT in the conventional art. During the process of laser transferring, a mask may be used to further increase the resolution of the fabricated CNT pattern. Also, by the method, the problem of the remaining catalyst metal on the conductive substrate may be avoided, and the process cost of removing the catalyst metal is omitted. Further, the operation is suitable for being performed at the atmospheric room temperature, thus an efficient method with convenient and simplified manufacturing process is provided.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIGS. 1 to 3 are schematic exploded views of the method of fabricating CNT pattern according to the present invention.

FIG. 4 is a schematic view of the CNT pattern fabricated according to the present invention.

### DETAILED DESCRIPTION OF THE INVENTION

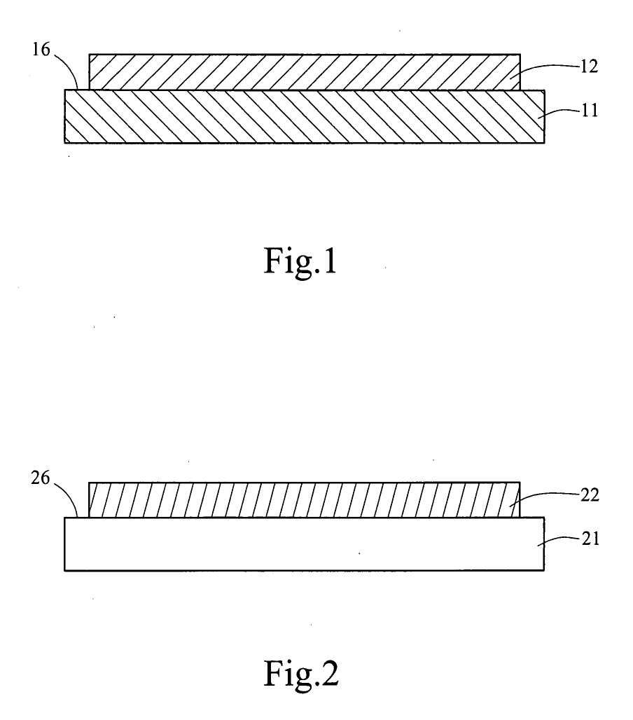

Please refer to FIGS. 1 to 3 of schematic exploded views of the method of fabricating CNT pattern according to the present invention. As shown in FIGS. 1 to 3, in the method of fabricating CNT pattern of the present invention, a first substrate 21 made of transparent material is provided first, and a uniformly distributed CNT thin film layer 22 with a preset thickness is formed on a first surface 26 of the first substrate 21. Next, a second substrate 11 is provided, and a layer of conductive adhesive paste 12 is coated on a second surface 16 of the second substrate, and the first surface 26 and the second surface 16 are made to dispose correspondingly, as shown in FIG. 3. Moreover, a mask 14 with a plurality of through holes 15 is further disposed on the surface of the conductive paste 12. Finally, a laser emitter 30 is used to emit a laser beam to irradiate the CNT thin film layer 22 on the first substrate 21, such that the CNT departs from the first surface 26, passes through the mask 14 with a plurality of through holes and embeds in the conductive paste 12. Therefore, a CNT pattern is attached on the second surface 16.

Moreover, the silver paste is selected as the conductive paste 12 of the present embodiment, but the present invention is not limited by the silver paste, any conductive adhesive that may bind the CNT to the second substrate 11 may be used as the material of the conductive paste 12 of the present invention, so as to make the second surface 16 of the second substrate 11 stably binds the CNT deposited thereon.

As shown in FIG. 2, in the present embodiment, as for the method of forming the CNT thin film layer 22 on the first surface 26 of the first substrate 21, enough CNTs are taken and uniformly dissolved in the alcohol solution first, so as to form a CNT solution. Then, the alcohol solution with the CNT is uniformly coated on the first surface 26 of the first substrate 21 by using the thin film deposition method, for example, with the spin coating or drop coating. After the alcohol is totally vaporized over a period of time, a uniformly distributed CNT thin film layer 22 with a preset thickness is formed on the first surface 26. In the present embodiment, the preset thickness of the CNT thin film layer 22 is about 20 μm.

As shown in FIG. 3, the laser emitter 30 adopted by the present embodiment is a Nd:YAG pulse laser with a wavelength of 1064 nm, and the pulse time thereof is 10 ns. Because the first substrate 21 is a transparent substrate, the laser beam irradiated may pass through the first substrate 21 to irradiate onto the CNT thin film layer 22 on the first surface 26. The CNT on the CNT thin film layer 22 irradiated by the laser pulse absorbs the laser pulse, resulting in high temperature locally around the irradiated area, such that the CNT explodes to depart from the first surface 26. The exploded and ejected CNT after being irradiated may move towards the direction of the second substrate 11, wherein a part of the CNT may be attached on the mask 14, and another part of the CNT may pass through the plurality of through holes 15 on the mask 14 to be bound to the conductive paste 12. Further, the mask 14 of the present embodiment uses the steel mask.

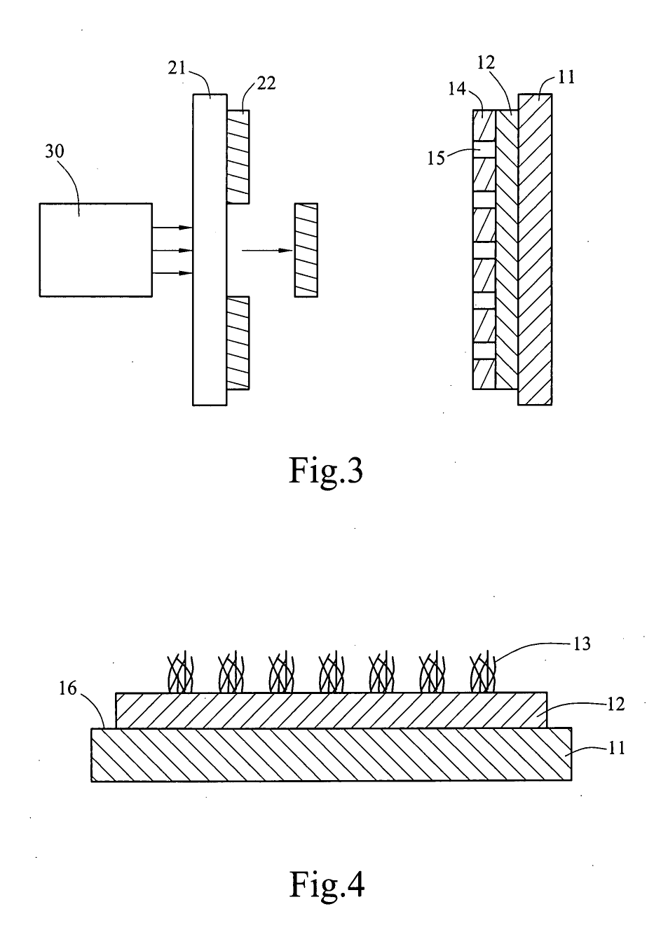

As shown in FIG. 4, the mask 14 is removed from the surface of the conductive paste 12, so a CNT pattern 13 may be formed on the second substrate 11 according to the pattern of the plurality of through holes 15 of the mask 14.

In another embodiment of the present invention, the main part is the same as that of the above embodiment, the main difference is in the step of binding the CNT to the second substrate 11. In the first embodiment, a layer of conductive adhesive paste 12 is coated on the second surface 16 of the second substrate 11 to achieve the binding of the CNT and the substrate. However, in this embodiment, the conductive adhesive paste is mixed into the CNT solution first, and then the mixture is coated on the first surface 26 of the first substrate 21 to form a CNT thin film layer 22. Therefore, when irradiated by the laser emitter 30, the conductive adhesive paste and the CNT deposited on the first surface 26 may explode and eject out because of the local high temperature, and may be deposited on the second surface 16 of the second substrate 11. Here, because of the adherence of the conductive paste, the CNT may be stably attached on the second surface 16. In yet another embodiment, instead of mixing together, after the CNT thin film layer 22 is formed on the first surface 26 of the first substrate 21, a layer of conductive adhesive paste 12 is coated on the surface of the CNT thin film layer 22. In this manner, after exploding due to the local high temperature around the laser irradiated area and ejecting out, the CNT thin film layer 22 with the layer of conductive adhesive paste is stably attached on the second surface 16. In one more embodiment, a layer of conductive adhesive paste 22 is first deposited on the first surface 26 of the first substrate 21, followed by the deposition of the CNT thin film layer 22 on top of the conductive paste. When irradiated by the laser beam, the local high temperature causes the conductive paste and the CNT thin film departing from the first surface 26 and stably bound to the second substrate 11.

The method of fabricating CNT pattern of the present invention may be applied to the CNT-FED technology, which includes the following steps. First, the second substrate 11 with the CNT pattern 13 is put into a vacuum chamber. Next, appropriate electrode connecting lines are disposed on the second substrate 11, and a fluorescent plate covers thereon, so as to finish the arrangement of the CNT-FED. Because in the present invention, the CNT is externally embedded into the conductive paste 12 on the second substrate 11, when the present invention is applied to the CNT-FED, the hidden trouble that the CNT is covered by the silver paste when using the screen printing method is avoided, and the post-processing for removing the remaining catalyst metal layer when using the CVD is omitted.

To sum up, the present invention provides a method of fabricating CNT pattern, which is capable of exactly controlling the thickness of the CNT pattern 13 formed on the second substrate 11. A controlling condition in the method of the present invention is that by adjusting the thickness of the CNT thin film layer 22 deposited on the first surface 26, the thickness of the CNT pattern 13, laser transferred on to the second substrate 11, is controlled indirectly. Another controlling condition is that by controlling the irradiating amount of the laser light irradiating on the CNT thin film layer 22 of the first surface 26, the ejected amount of the CNT thin film layer 22 after the explosion due to the locally induced high temperature is influenced directly. The more the irradiating amount of the laser light, the more the energy absorbed by the irradiated CNT thin film layer 22, thus the more the ejected amount due to high temperature, and the thicker the thickness of the CNT pattern 13 transferred onto the second substrate 11. The irradiating amount of the laser light is determined by adjusting the laser emission intensity of the laser emitter 30 or is determined by adjusting the size of the irradiation area of the laser light irradiating on the CNT thin film layer 22. The irradiating amount of the laser light is proportional to the laser emission intensity and the irradiation area.

The present invention may generate the CNT pattern with high resolution, and the size of a single pattern may be as small as 10 μm. Meanwhile, the CNTs are uniformly distributed, and have favorable adhesion and quick deposition rate of the CNT pattern. Moreover, the present invention may be realized at the atmospheric room temperature environment, offering a simple and low cost process for fabricating the CNT pattern.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of fabricating carbon nanotube (CNT) pattern, comprising:
providing a first substrate with a first surface;
coating a CNT thin film layer with a predetermined thickness on the first surface of the first substrate;
providing a second substrate with a second surface corresponding to the first surface of the first substrate; and
providing a laser emitter for emitting a laser light onto the first substrate, such that the irradiated CNT thin film layer on the first surface departs from the first surface and adheres on the second surface, so as to form a CNT pattern.

2. The method of fabricating CNT pattern as claimed in claim 1, wherein the first substrate is a transparent substrate.

3. The method of fabricating CNT pattern as claimed in claim 1, further comprising:
uniformly dissolving the CNT in a solvent to form a CNT solution; and
uniformly coating the CNT solution on the first surface to form the CNT thin film layer.

4. The method of fabricating CNT pattern as claimed in claim 3, wherein the solvent is ethanol.

5. The method of fabricating CNT pattern as claimed in claim 3, wherein the method of coating the CNT solution on the first surface comprises depositing the CNT solution on the first surface by a thin film deposition method.

6. The method of fabricating CNT pattern as claimed in claim 3, wherein the method of coating the CNT solution on the first surface comprises:
dropping the CNT solution on the first surface with a pipette.

7. The method of fabricating CNT pattern as claimed in claim 5, wherein the thin film deposition method is spin coating method.

8. The method of fabricating CNT pattern as claimed in claim 3, further comprising:
mixing an adhesive material in the solvent, and coating the resultant CNT solution on the first substrate, so as to form the CNT thin film layer with adhesive material.

9. The method of fabricating CNT pattern as claimed in claim 3, wherein before the step of uniformly coating the CNT solution on the first surface to form the CNT thin film layer, the method further comprises:
coating an adhesive layer on the first surface.

10. The method of fabricating CNT pattern as claimed in claim 3, wherein after the step of uniformly coating the CNT solution on the first surface to form the CNT thin film layer, the method further comprises:
coating an adhesive on the CNT thin film layer.

11. The method of fabricating CNT pattern as claimed in claim 1, wherein the laser emitter is a laser emitter with a specific wavelength.

12. The method of fabricating CNT pattern as claimed in claim 1, further comprising:
disposing a mask between the first substrate and the second substrate, so as to form the CNT pattern corresponding to the pattern on the mask.

13. The method of fabricating CNT pattern as claimed in claim 12, wherein the mask has a plurality of through holes, and a preset distance is provided between the through holes.

14. The method of fabricating CNT pattern as claimed in claim 1, further comprising:
coating an adhesive layer on the second surface of the second substrate, so as to enhance the adhesion between the CNT pattern and the second substrate.

15. The method of fabricating CNT pattern as claimed in claims 1, wherein the CNT pattern is applicable to fabricating the Carbon Nanotube Field Emission Display (CNT-FED).

16. The method of fabricating CNT pattern as claimed in claim 1, wherein the thickness of the CNT pattern is controlled by controlling the thickness of the CNT thin film layer on the first surface.

17. The method of fabricating CNT pattern as claimed in claim 1, wherein the thickness of the CNT pattern is controlled by controlling the irradiation amount of the laser light irradiating on the CNT thin film layer on the first surface.

18. The method of fabricating CNT pattern as claimed in claim 17, wherein the irradiating amount of the laser light is controlled by adjusting the laser emission intensity of the laser emitter.

19. The method of fabricating CNT pattern as claimed in claim 17, wherein the irradiating amount of the laser source is controlled by adjusting the irradiation area of the laser light irradiating on the CNT thin film layer.
